(19) United States
(12) Patent Application Publication
(10) Pub. No.: US 2023/0122506 A1
(43) Pub. Date: Apr. 20, 2023

(54) Three-Dimensional Printing System with Offset Flat Field Unit

(71) Applicant: LAYERWISE NV, Leuven (BE)

(72) Inventor: Sam Coeck, Boutersem (BE)

(21) Appl. No.: 17/965,076

(22) Filed: Oct. 13, 2022

Related U.S. Application Data
(60) Provisional application No. 63/255,641, filed on Oct. 14, 2021.

(51) Int. Cl. B22F 12/49; B22F 12/30; B22F 12/50; B22F 12/41; B22F 10/28; B33Y 30/00

(52) U.S. Cl. CPC B22F 12/49; B22F 12/30; B22F 12/50; B22F 12/41; B22F 10/28; B33Y 30/00

(57) ABSTRACT

A three-dimensional printing system includes a motorized build platform, a material coating module, and a beam generation module. The beam generation module is configured to selectively fuse or harden material over a build plane. The build plane defines a centroid. The beam generation module includes a laser beam formation unit, a scan module, and flat field focusing component (FFFC). The scan module has a scanner optical axis that intersects the build plane at a location that is offset from the centroid. The FFFC is configured to focus the laser beam across the build plane. The FFFC includes a plurality of lenses at least one of which has an optical asymmetry relative to the scanner optical axis. The asymmetry includes one or more of a lateral offset with an offset distance D and an angular offset with an offset angle α.

### CROSS-REFERENCE TO RELATED APPLICATIONS

This non-provisional patent application claims priority to U.S. Provisional Application Ser. No. 63/255,641, Entitled “Three-Dimensional Printing System with Offset Flat Field Unit” by Sam Coeck, filed on Oct. 14, 2021, incorporated herein by reference under the benefit of U.S.C. 119(e).

### FIELD OF THE INVENTION

The present disclosure concerns an apparatus and method for a layer-by-layer fabrication of three dimensional (3D) articles by a laser beam-induced solidification or fusion of layers of material such as polymer powders, metal powders, and photocurable resins. More particularly, the present disclosure concerns optics to improve uniformity of a focus of a radiation beam over a build plane having a centroid that is laterally offset from a scanner optical axis.

### BACKGROUND

Three dimensional (3D) printing systems are in rapidly increasing use for purposes such as prototyping and manufacturing. Certain 3D printing systems utilize layer-by-layer processes to form 3D articles from various materials which can be metal powders, plastic powders, and photocurable resins. For individual material layers, there is a need to selectively fuse, cure, or solidify portions of the material layer by scanning a radiation beam over an area of the material layer. To provide a consistent resolution and material properties, the laser beam should have a consistent focus over the area which is otherwise referred to as a build plane. This can be particularly challenging when system geometric design factors prevent a symmetrical relationship between portions of system optics and the build plane.

### SUMMARY

In an aspect of the disclosure, a three-dimensional printing system includes a motorized build platform, a material coating module, and a beam generation module. The beam generation module is configured to selectively fuse or harden material over a build plane. The build plane has or defines a centroid. The beam generation module includes a laser beam formation unit, a scan module, and flat field focusing component (FFFC). The laser beam formation unit includes a laser configured to output a laser beam. The scan module has a scanner optical axis that intersects the build plane at a location that is offset from the centroid. The FFFC is configured to focus the laser beam across the build plane. The FFFC includes a plurality of lenses, at least one of which has an optical asymmetry relative to the scanner optical axis. The optical asymmetry includes one or more of a lateral offset with an offset distance D and an angular offset with an offset angle α. The optical asymmetry improves uniformity of focusing of the laser beam over the build plane.

In one implementation, the asymmetry includes the lateral offset with the offset distance D. The offset distance D can be at least 0.5 millimeter, at least 1.0 millimeter, at least 2 millimeters, or at least 3 millimeters. The offset distance D can be in a range of 3 to 4 millimeters or about 4 millimeters.

In another implementation, the asymmetry includes the angular offset with the offset angle α. The offset angle α can be at least 0.5 degrees, at least 1.0 degrees, at least 2.0 degrees, or at least 3 degrees.

In yet another implementation, the asymmetry includes the lateral offset and the angular offset. The offset distance D can be at least 0.5 millimeter, at least 1.0 millimeter, at least 2 millimeters, or at least 3 millimeters. The offset angle α can be at least 0.5 degrees, at least 1.0 degrees, at least 2.0 degrees, or at least 3 degrees.

In a further implementation, the plurality of lenses includes at least three lenses. The lenses can include a diverging lens and two converging lenses. The optical axes of two or three of the plurality of lenses can have the optical asymmetry. The optical asymmetry have small variations (of angle and/or offset distance) between individual ones of the two or three of the plurality of lenses that have the optical asymmetry.

In a yet further implementation, the three-dimensional printing system can include a plurality of such beam generation modules. The plurality of beam generation modules can operate simultaneously.

In another implementation, the three-dimensional printing system includes a controller configured to: (a) operate the motorized build platform to vertically position an upper surface of the motorized build platform or build material, (b) operate the material coating module to form a new layer of material over the upper surface, and (c) operate the beam generation module to selectively harden the new layer of material. The controller repeats (a)-(c) to complete manufacture or fabrication of a three-dimensional article.

In yet another implementation the material coating module Is configured to deposit a new layer of powder over the motorized build platform. The build plane is defined on an upper surface of the new layer of powder. The powder can include one or more of a metal, polymer, or ceramic. A metal powder can include a single element metal powder or an alloy. The alloy can include more than one type of metal and/or a metal and a ceramic. For powders containing metal and/or ceramic, the laser beam can have an average power level of at least 100 watts, at least 200 watts, at least 500 watts, or at least 1000 watts. The laser has the effect of fusing and/or melting portions of the powder to consolidate the powder into a generally composite material.

In a further implementation, the material coating module is configured to deposit a liquid polymer resin over the motorized build platform. The liquid polymer resin can be photocurable by blue, violet, and/or ultraviolet radiation. The effect of photocuring the resin is to solidify and/or harden the resin.

### BRIEF DESCRIPTION OF THE FIGURES

FIG. 1 is a schematic diagram of a three-dimensional printing system.

FIG. 2 is a schematic diagram of a beam generation subsystem.

FIG. 3 is a schematic diagram illustrating a first embodiment of some optical components of a beam generation subsystem.

FIG. 4 is a schematic diagram illustrating a second embodiment of some optical components of a beam generation subsystem.

### DETAILED DESCRIPTION OF THE PREFERRED EMBODIMENTS

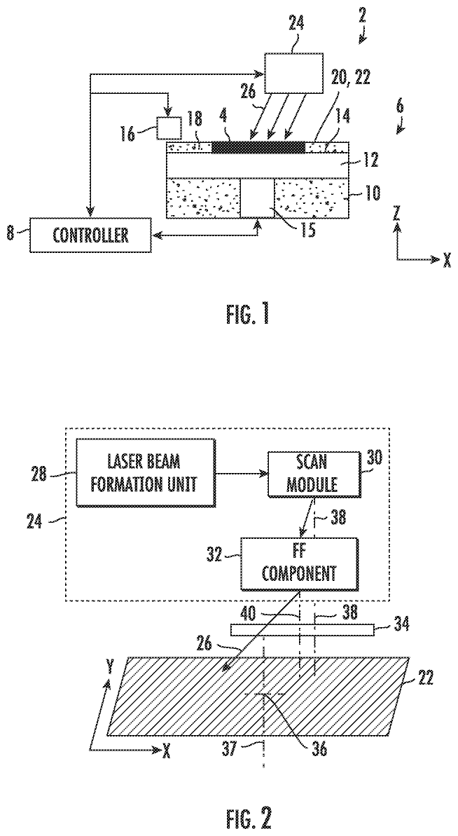

FIG. 1 is a schematic diagram of a three-dimensional (3D) printing system 2 for forming a 3D article 4. In describing 3D printing system 2, mutually orthogonal axes X, Y and Z can be used. Axes X and Y are lateral axes that are generally horizontal. Axis Z is a vertical axis that is generally aligned with a gravitational reference. The modifier “generally” applied to a direction, magnitude, alignment or other factor indicates that the relationship is by design but may not be exact due to mechanical tolerances or other factors.

The 3D printing system 2 includes a 3D print engine 6 coupled to a controller 8. The controller 8 can include a single computer co-located with the print engine 6 or it can include two or more computers, some of which are physically separated from or even remotely located relative to the print engine 6.

The print engine 6 includes a build container 10 containing a motorized build platform 12. Motorized build platform 12 has an upper surface 14 and a mechanism 15 (details not shown) for precisely vertically positioning build platform 12. The mechanism 15 can include a mechanical drive such as a rack and pinion, lead screw, or other drive system. A lead screw drive system can include a lead screw coupled to a fixed motor. The lead screw can be received into a threaded nut that is coupled to the build platform 12. Under command of the controller 8, the motor can turn the lead screw to vertically position the build platform 12. Other vertically positioning mechanisms 15 are possible and may be conventionally known.

Print engine 6 includes a material coating module 16 that is configured to form a uniform layer of material 18 such as metal powder over the motorized build platform 12. When a new uniform layer of material 18 is formed, an upper surface 20 of the new uniform layer of material 18 can be referred to as partly defining a “build plane 22” or multiple overlapping build planes 22. A material coating module 16 can include a dispenser for dispensing the material 18 and a wiper blade for assuring a planar and uniform surface 20. Motion of the material coating module 16 during dispensing and wiping can be imparted by a motorized lead screw, a motorized belt, or other motorized movement mechanism. In an illustrative embodiment, the material coating module 16 is translated via a belt that is suspended and supported between two pulleys including a drive pulley. The drive pulley is coupled to a motor and has sprockets received into sprocket holes of the belt. The material coating module is coupled to the belt. Thus, when the motor turns the drive pulley, the effect is to translate the portion of the belt that is attached to the coating module 16 which translates the coating module.

The print engine 6 includes a beam generation module 24 which is configured to generate and scan a focused laser beam 26 over a single build plane 22 to selectively harden or fuse a new layer of material 18 under control of controller 8. In some embodiments, system 2 includes plural beam generation modules 24 for addressing plural and coplanar but different build planes 22. The discussion that follows concerns one single beam generation module 24 for scanning one beam 26 over one plane field 22 but it is to be understood that the system 2 may include more than one optical module 24 for addressing different coplanar build fields 22.

The controller 8 is configured to operate portions of the print engine 6 to manufacture or fabricate the 3D article 4. The controller is configured to: (a) receive a data file defining 3D article 4, (b) process the data file to prepare it for operating print engine 6, (c), operate the motorized build platform 12 to position an upper surface 14 or 20 proximate to build plane 22, (c) operate the material coating module 16 to apply a new layer of build material 18 to the upper surface 14 or 20, (d) operate the beam generation module 24 to selectively harden or fuse the new layer of build material 18, and repeat (c)-(d) to complete manufacture or fabrication of article 4.

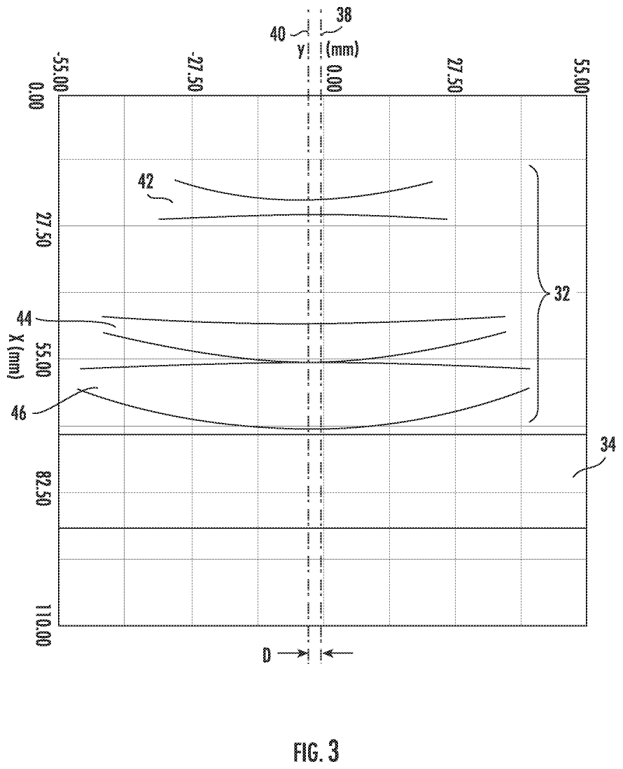

FIG. 2 is a schematic diagram of a beam generation module 24 for scanning a beam 26 over a build plane 22. The beam generation module 24 includes a laser beam formation unit 28, a scan module 30, a flat field focusing component (FFFC) 32, and a window 34. The build plane 22 has a centroid 36. Centroid 36 is located at a lateral center of mass of the build plane 22 which is a geometric center of the build plane 22 area. A central normal 37 for the build plane 22 is defined as an axis that passes through the centroid 36 and is normal or perpendicular to the build plane 22.

The laser beam formation module 28 includes a laser (not shown) and associated optics for forming laser beam 26. The laser beam 26 emitted by the laser beam formation module 24 is collimated which means that the light is accurately parallel. Laser beam formation modules 28 are known in the art for 3D printing.

The scan module 30 is configured to reflect the laser beam 26 onto the build plane 22. Also, the scan module 30 is configured to scan the laser beam 26 across the build plane 22 in X and Y. In the illustrated embodiment, the scan module 30 includes a pair of motorized mirrors including an X-mirror and a Y-mirror. The mirrors can be referred to as “galvanometer scanning mirrors”. The laser beam 26 from the laser beam formation module 28 impinges upon the X-mirror, reflects to the Y-mirror, and then down to the build plane 22. Controlled motorized motion of the X-mirror translates the laser beam 26 along the X-axis of build plane 22. Controlled motorized motion of the Y-mirror translates the laser beam 26 along the Y-axis of build plane 22.

The scan module 30 has a “zero position” at which the laser beam 26 is reflected generally perpendicular to the build plane 22. This zero position defines an optical axis 38 for the scan module 30. Due to geometric constraints, the optical axis 38 is offset laterally from the central normal 37 for the build plane 22.

The flat field component 32 is an optical system of lenses that is configured to consistently focus the laser beam 26 over the build plane 22 regardless of position in X and Y. The flat field component 30 includes a plurality of lenses in series. At least one of the plurality of lenses has an optical asymmetry relative to the scanner optical axis 38. The optical asymmetry can include one or more of (1) a lateral offset relative to the scanner optical axis and (2) an angular offset relative to the scanner optical axis.

In an illustrative embodiment, the plurality of lenses includes at least one lens having a lens optical axis 40 that is offset from the optical axis 38 of the scan module 30. This offset improves the effectiveness of the flat field component in providing a focus over the entire build plane 22.

A magnitude of lateral offset between the scan module 30 optical axis 38 and the lens optical axis 40 can be referred to as an offset distance D. Offset distance D can be at least 0.5 millimeter, at least 1 millimeter, at least 2 millimeters, at least 3 millimeters, in a range of 3 to 4 millimeters, or take on other values depending on a size and geometry of the system 2.

FIG. 3 is an optical diagram illustrating a first embodiment of a three lens FFFC 32 and the window 34. The illustrated 3 lens FFFC 32 includes a diverging lens 42, a first converging lens 44, and a second converging lens 46. The optical axis 40 of the three lenses 42-46 is shown shifted by offset D relative to the scan module 38 optical axis 38. In fact, the offset D can vary individually for the three lenses 42-46 but for simplicity a single lens optical axis 40 is illustrated. This offset optimizes the focus of the laser beam 26 over the build plane 22. In various illustrative examples, D can take on various values including at least 0.5 millimeter, at least 1.0 millimeter, at least 2 millimeters, at least 3 millimeters, within a range of 3 to 4 millimeters, or about 4 millimeters.

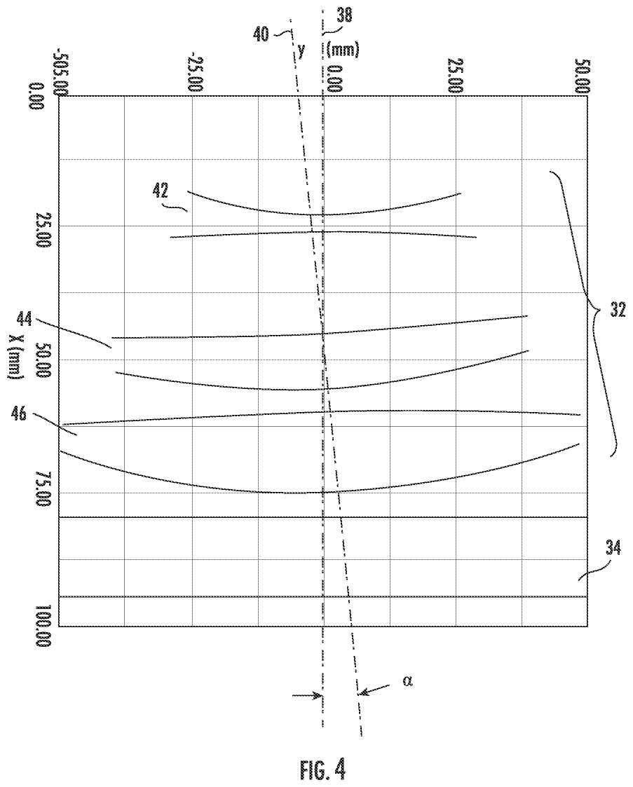

FIG. 4 is an optical diagram illustrating a second embodiment of a three lens FFFC 32 and the window 34. The illustrated 3 lens FFFC 32 includes a diverging lens 42, a first converging lens 44, and a second converging lens 46. The optical axis 40 of the first converging lens 44 is shown angularly offset or tilted by an offset angle α. The angle α can be at least 0.5 degrees, at least 1.0 degrees, at least 2.0 degrees, or at least 3 degrees.

In a third embodiment—not illustrated—the offset can include a combination of a linear offset D and an angular offset a. The offset distance D can be at least 0.5 millimeter, at least 1.0 millimeter, at least 2 millimeters, or at least 3 millimeters. The offset angle α can be at least 0.5 degrees, at least 1.0 degrees, at least 2.0 degrees, or at least 3 degrees.

The specific embodiments and applications thereof described above are for illustrative purposes only and do not preclude modifications and variations encompassed by the scope of the following claims.

What is claimed:

1. A three-dimensional printing system comprising:
a motorized build platform;
a material coating module;
a beam generation module configured to selectively fuse or harden material over a build plane, the build plane having a centroid, the beam generation module including:
a laser beam formation unit including a laser configured to output a laser beam;
a scan module having a scanner optical axis that intersects the build plane at a location that is offset from the centroid;
a flat field focusing component configured to focus the laser beam across the build plane, the flat field focusing component including a plurality of lenses, at least one of the plurality of lenses has an optical asymmetry relative to the scanner optical axis, the asymmetry includes one or more of a lateral offset with an offset distance D and an angular offset with an offset angle α.

2. The three-dimensional printing system of claim 1 wherein the asymmetry includes the lateral offset with the offset distance D of at least 0.5 millimeter.

3. The three-dimensional printing system of claim 1 wherein the asymmetry includes the lateral offset with the offset distance D of at least 1.0 millimeter.

4. The three-dimensional printing system of claim 1 wherein the asymmetry includes the lateral offset with the offset distance D of at least 2 millimeters.

5. The three-dimensional printing system of claim 1 wherein the asymmetry includes the lateral offset with the offset distance D of at least 3 millimeters.

6. The three-dimensional printing system of claim 1 wherein the asymmetry includes the angular offset with the offset angle α of at least 0.5 degrees.

7. The three-dimensional printing system of claim 1 wherein the asymmetry includes the angular offset with the offset angle α of at least 1.0 degrees.

8. The three-dimensional printing system of claim 1 wherein the asymmetry includes the angular offset with the offset angle α of at least 2 degrees.

9. The three-dimensional printing system of claim 1 wherein the asymmetry includes the angular offset with the offset angle α of at least 3 degrees.

10. The three-dimensional printing system of claim 1 wherein the asymmetry includes the lateral offset with the offset distance D of least 0.5 millimeter and also includes the angular offset with the offset angle α of at least 0.5 degrees.

11. The three-dimensional printing system of claim 1 wherein the plurality of lenses includes at least three lenses.

12. The three-dimensional printing system of claim 11 wherein at least two of the plurality of lenses have the optical asymmetry relative to the scanner optical axis.

13. The three-dimensional printing system of claim 11 wherein at least three of the plurality of lenses have the optical asymmetry relative to the scanner optical axis.

15. The three-dimensional printing system of claim 13 wherein the optical asymmetry includes the lateral offset for the at least three of the plurality of lenses.

16. The three-dimensional printing system of claim 1 further comprising a controller configured to:
operate the motorized build platform to vertically position an upper surface of the motorized build platform or build material;
operate the material coating module to form a new layer of material over the upper surface; and
operate the beam generation module to selectively harden the new layer of material.

17. The three-dimensional printing system of claim 1 wherein the material coating module is configured to deposit a layer of material over the motorized build platform, the layer of material includes one or more of a liquid material and a powder material.

18. The three-dimensional printing system of claim 17 wherein the layer of material includes one or more of a polymer, a metal, a ceramic, and an alloy.

19. The three-dimensional printing system of claim 18 wherein the layer of material is a powder including one or more of a metal powder, a ceramic powder, and an alloy powder.

20. The three-dimensional printing system of claim 19 wherein the laser beam has a power level of at least 100 watts.
